(19) United States
(12) Patent Application Publication
(10) Pub. No.: US 2025/0286162 A1
(43) Pub. Date: Sep. 11, 2025

(54) POWER STORAGE DEVICE

(71) Applicant: TOYOTA JIDOSHA KABUSHIKI KAISHA, Toyota-shi (JP)

(72) Inventor: Shinya Goitsuka, Nisshin-shi (JP)

(73) Assignee: TOYOTA JIDOSHA KABUSHIKI KAISHA, Toyota-shi (JP)

(21) Appl. No.: 19/037,866

(22) Filed: Jan. 27, 2025

(30) Foreign Application Priority Data
Mar. 8, 2024 (JP) 2024-035925

(51) Int. Cl. H01M 10/613; H01M 10/625; H01M 10/647; H01M 10/6556; H01M 50/209; H01M 50/264

(52) U.S. Cl. CPC H01M 10/613; H01M 10/625; H01M 10/647; H01M 10/6556; H01M 50/209; H01M 50/264; H01M 2220/20

(57) ABSTRACT

A power storage device includes: a first power storage module and a second power storage module arranged in a first direction; and a first cooler located between the first power storage module and the second power storage module. Each of the first power storage module and the second power storage module includes a first target component at only one end portion of two end portions in the first direction, and each of the first power storage module and the second power storage module is disposed such that the end portion including the first target component faces away from the first cooler.

### CROSS REFERENCE TO RELATED APPLICATIONS

This nonprovisional application is based on Japanese Patent Application No. 2024-035925 filed on Mar. 8, 2024 with the Japan Patent Office, the entire contents of which are hereby incorporated by reference.

### BACKGROUND

### Field

The present disclosure relates to a power storage device including a plurality of power storage modules.

### Description of the Background Art

Japanese Patent Laying-Open No. 2018-073552 discloses a power storage device including a plurality of power storage modules and a cooler disposed between the power storage modules. In the power storage device, an elastic member presses the cooler against one of the two power storage modules located on both sides of the cooler.

### SUMMARY

In the power storage device described in Japanese Patent Laying-Open No. 2018-073552, the cooler cools only one power storage module (power storage module pressed by the elastic member). With regard to the power storage device including the plurality of power storage modules, there is a room for improvement in cooling efficiency.

The present disclosure has been made to solve the above-described problem, and an object thereof is to efficiently and appropriately cool a power storage device including a plurality of power storage modules.

According to a first aspect of the present disclosure, a power storage device described below is provided.

(Clause 1) The power storage device includes: a first power storage module and a second power storage module arranged in a first direction; and a first cooler located between the first power storage module and the second power storage module. Each of the first power storage module and the second power storage module includes a first target component at only one end portion of two end portions in the first direction, and each of the first power storage module and the second power storage module is disposed such that the end portion including the first target component faces away from the first cooler.

As described above, one cooler (first cooler) is disposed between the plurality of power storage modules (the first power storage module and the second power storage module), which makes it easy to efficiently cool the power storage device. In addition, since the first target component of each of the first power storage module and the second power storage module is disposed away from the first cooler, excessive cooling of the first target component by the first cooler is suppressed. Therefore, the above-described configuration makes it possible to efficiently and appropriately cool the power storage device including the plurality of power storage modules. The first target component may be a component that is likely to malfunction due to excessive cooling.

(Clause 2) In the power storage device according to clause 1, the first target component included in the first power storage module includes at least one of an exhaust valve of the first power storage module, a positive electrode terminal of the first power storage module, and a negative electrode terminal of the first power storage module, and the first target component included in the second power storage module includes at least one of an exhaust valve of the second power storage module, a positive electrode terminal of the second power storage module, and a negative electrode terminal of the second power storage module.

The exhaust valve, the positive electrode terminal and the negative electrode terminal may malfunction due to excessive cooling. For example, a malfunction may occur due to dew condensation caused by excessive cooling. The above-described configuration makes it possible to suppress excessive cooling of at least one of the exhaust valve, the positive electrode terminal and the negative electrode terminal.

(Clause 3) In the power storage device according to clause 1 or 2, the first power storage module and the second power storage module have the same configuration.

Since the plurality of power storage modules having the same configuration are used, manufacturing of the power storage device is facilitated. In addition, the first power storage module and the second power storage module are cooled by the first cooler in the same way. Thus, performance variation between the power storage modules caused by temperature distribution variation is suppressed. By disposing the two power storage modules having the same structure such that one of the two power storage modules is rotated with respect to the other by 180°, the first target component of each of the power storage modules can be disposed away from the first cooler.

(Clause 4) In the power storage device according to any one of clauses 1 to 3, a first heat conducting member is provided between the first power storage module and the first cooler in the first direction. A second heat conducting member is provided between the second power storage module and the first cooler in the first direction.

According to the above-described configuration, heat conductivity between each of the first power storage module and the second power storage module and the first cooler is improved. Each of the heat conducting members has heat conductivity higher than that of air (air gap), for example. The first heat conducting member and the second heat conducting member may be made of the same material, or may be made of different materials.

(Clause 5) The power storage device according to any one of clauses 1 to 4 further includes a first bracket. Each of the first power storage module and the second power storage module is fixed to the first bracket.

As described above, the first power storage module and the second power storage module are fixed to the common bracket (first bracket), which makes it easy to dispose the first power storage module and the second power storage module at prescribed positions.

(Clause 6) In the power storage device according to clause 5, the first cooler and the first bracket are disposed to be arranged in a second direction orthogonal to the first direction. A recessed portion into which the first bracket is inserted is formed in an end surface in the second direction of each of the first power storage module and the second power storage module.

The recessed portion formed as described above makes it easy to assemble the first power storage module and the second power storage module to the first bracket.

(Clause 7) In the power storage device according to clause 6, a portion of the first bracket inserted into the recessed portion is provided with a female thread extending through the portion in the first direction. A first bolt that fastens the first power storage module to the first bracket is screwed into the female thread. A second bolt that fastens the second power storage module to the first bracket is screwed into the female thread.

The above-described configuration makes it easy to fasten the first power storage module and the second power storage module to the first bracket from both sides in the first direction of the first bracket.

(Clause 8) In the power storage device according to clause 7, a first step is formed in an end surface opposite to the first cooler in the first direction of the first power storage module. The first bolt extends through a portion of the first power storage module having a thickness reduced by the first step. A second step is formed in an end surface opposite to the first cooler in the first direction of the second power storage module. The second bolt extends through a portion of the second power storage module having a thickness reduced by the second step.

The above-described configuration makes it easy to adopt a short bolt as each of the first bolt and the second bolt. By fastening each of the first power storage module and the second power storage module to the first bracket using the short bolt, the fastening becomes hard to loosen.

(Clause 9) In the power storage device according to any one of clauses 1 to 8, paste-like heat conducting members are applied to two end surfaces located at ends in the first direction of the first cooler.

According to the above-described configuration, heat conductivity between each of the first power storage module and the second power storage module and the first cooler is improved. In addition, when the configuration according to clause 9 is applied to the power storage device according to clause 7 or 8, control of the thicknesses of the heat conducting members becomes easy. By fastening the first power storage module and the second power storage module to the first bracket from both sides in the first direction of the first bracket, the thicknesses of the heat conducting members on the two end surfaces can be easily made equal.

(Clause 10) The power storage device according to any one of clauses 5 to 9 further includes a cross member. The first bracket is fastened to the cross member.

The above-described configuration makes the first bracket easy to stabilize. Since the first bracket is stabilized, misalignment between the first power storage module and the second power storage module is less likely to occur. The cross member is a member that constitutes a frame of the power storage device or a product (e.g., a vehicle) on which the power storage device is mounted. The cross member may constitute a case of a battery pack, or may be a floor cross of a vehicle. The cross member may function as an energy absorbing (EA) member.

(Clause 11) In the power storage device according to any one of clauses 5 to 10, the first cooler includes a first cooling port through which refrigerant flows into the first cooler, and a second cooling port through which the refrigerant flows out from the first cooler. At least one of the first cooling port and the second cooling port is provided such that displacement in the first direction is suppressed by the first bracket.

According to the above-described configuration, displacement of the cooling port (at least one of the first cooling port and the second cooling port) is suppressed by the first bracket. Therefore, damage to the cooling port caused by the external force can be suppressed.

(Clause 12) In the power storage device according to clause 11, the first cooler further includes a port support portion that supports the first cooling port or the second cooling port.

According to the above-described configuration, the cooling port (the first cooling port or the second cooling port) is supported by the first cooler. Thus, it is not necessary to separately prepare a member for supporting the cooling port.

(Clause 13) The power storage device according to clause 12 further includes a cross member. The port support portion is provided to overlap with the cross member in the first direction.

As described above, the port support portion is provided in the portion where the cross member having high rigidity is provided, and thus, the rigidity of the port support portion and the surroundings thereof is reinforced.

(Clause 14) The power storage device according to clause 13 further includes: a third power storage module and a fourth power storage module arranged in the first direction; a second cooler that cools the third power storage module and the fourth power storage module; and a second bracket that holds the third power storage module and the fourth power storage module. At least a part of the second cooler is located between the third power storage module and the fourth power storage module in the first direction. The first power storage module and the third power storage module are disposed to be arranged in a second direction orthogonal to the first direction. The second power storage module and the fourth power storage module are disposed to be arranged in the second direction. The port support portion protrudes from between the first power storage module and the second power storage module toward the second cooler. The first cooling port or the second cooling port supported by the port support portion is located between the first power storage module and the third power storage module. The port support portion is provided such that displacement in the first direction is suppressed by the first bracket and the second bracket.

According to the above-described configuration, the cooling port (the first cooling port or the second cooling port) is disposed between the first power storage module and the third power storage module. Thus, assembly (joint assembly) of a pipe (refrigerant flow path) to the cooling port is facilitated. In addition, since displacement of the port support portion is suppressed by the first bracket and the second bracket, damage to the port support portion caused by a load applied to the cooling port during joint assembly can be suppressed. A portion of the port support portion on the first power storage module side and a portion of the port support portion on the third power storage module side may be supported in the manner of a both-end-supported beam.

(Clause 15) In the power storage device according to clause 14, the cross member includes (i) a portion located opposite to the first cooler in the first direction of the second power storage module, (ii) a portion protruding toward the port support portion between the second power storage module and the fourth power storage module, and (iii) a portion located opposite to the second cooler in the first direction of the fourth power storage module.

The effective use of space as described above makes it easy to provide a power storage device having excellent cooling performance and high volumetric energy density.

According to a second aspect of the present disclosure, a power storage device described below is provided.

(Clause 16) The power storage device includes: a first power storage module and a second power storage module arranged in a first direction; and a first cooler located between the first power storage module and the second power storage module. Each of the first power storage module and the second power storage module includes a second target component at only one end portion of two end portions in the first direction, and each of the first power storage module and the second power storage module is disposed such that the end portion including the second target component faces the first cooler.

As described above, one cooler (first cooler) is disposed between the plurality of power storage modules (the first power storage module and the second power storage module), which makes it easy to efficiently cool the power storage device. In addition, since the second target component of each of the first power storage module and the second power storage module is disposed on the first cooler side, the second target component can be preferentially cooled by the first cooler. Therefore, the above-described configuration makes it possible to efficiently and appropriately cool the power storage device including the plurality of power storage modules. The second target component may be a component to be preferentially cooled.

(Clause 17) In the power storage device according to clause 16, the second target component included in the first power storage module is a component that generates heat during charging or discharging of the first power storage module, and the second target component included in the second power storage module is a component that generates heat during charging or discharging of the second power storage module.

The above-described configuration makes it possible to suppress an excessive increase in temperature of the particular component (second target component) during charging or discharging of the power storage module.

(Clause 18) The power storage device according to any one of clauses 1 to 17 further includes: a third power storage module and a fourth power storage module arranged in the first direction; and a second cooler that cools the third power storage module and the fourth power storage module. At least a part of the second cooler is located between the third power storage module and the fourth power storage module in the first direction. The first power storage module and the third power storage module are disposed to be arranged in a second direction orthogonal to the first direction. The second power storage module and the fourth power storage module are disposed to be arranged in the second direction. The first cooler includes a first cooling port through which refrigerant flows into the first cooler, and a second cooling port through which the refrigerant flows out from the first cooler. The second cooler includes a third cooling port through which the refrigerant flows into the second cooler, and a fourth cooling port through which the refrigerant flows out from the second cooler. The first cooling port and the second cooling port are disposed to be arranged in a third direction orthogonal to both the first direction and the second direction. The third cooling port and the fourth cooling port are disposed to be arranged in the third direction.

The effective use of space as described above makes it easy to provide a power storage device having excellent cooling performance and high volumetric energy density.

(Clause 19) In the power storage device according to clause 18, the first cooling port and the third cooling port are connected to a common first flow path. The second cooling port and the fourth cooling port are connected to a common second flow path.

The above-described configuration makes it possible to supply the refrigerant from the first flow path to each of the first cooler and the second cooler, and cause the refrigerant flowing out from the first cooler and the refrigerant flowing out from the second cooler to flow through the second flow path together. Such a configuration makes it easy to efficiently and appropriately cool the power storage device including the plurality of power storage modules.

As another aspect, a vehicle including the power storage device according to any one of clauses 1 to 19 may be provided.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram of the inside of a power storage device according to an embodiment of the present disclosure when viewed from above.

FIG. 2 is a diagram of the inside of the power storage device according to the embodiment of the present disclosure when viewed from below.

FIG. 3 is a diagram showing a cooler according to the present embodiment after heat conducting members are provided.

FIG. 4 is a diagram showing the cooler shown in FIG. 3 before the heat conducting members are provided.

FIG. 5 is a diagram for illustrating a configuration of a bracket according to the present embodiment.

FIG. 6 is a diagram for illustrating a configuration of a power storage module according to the present embodiment.

FIG. 7 is a cross-sectional view taken along line VII-VII in FIG. 1.

FIG. 8 is a cross-sectional view taken along line VIII-VIII in FIG. 1.

FIG. 9 is a diagram showing an end portion of the power storage device shown in FIG. 1 on the −X side.

FIG. 10 is a diagram showing an example of a vehicle on which the power storage device according to the present embodiment is mounted.

FIG. 11 is a diagram showing a power storage device according to a first modification.

FIG. 12 is a diagram showing a power storage device according to a second modification.

### DESCRIPTION OF THE PREFERRED EMBODIMENTS

An embodiment of the present disclosure will be described in detail with reference to the drawings. In the drawings, the same or corresponding portions are denoted by the same reference characters and description thereof will not be repeated. In each figure used below, of an X axis, a Y axis and a Z axis that are orthogonal to one another, the X axis indicates a first in-plane direction (e.g., a length direction) of a power storage device, the Y axis indicates a second in-plane direction (e.g., a width direction) of the power storage device, and the Z axis indicates a height direction of the power storage device. Hereinafter, “+” is given to a direction indicated by an arrow of each of the X axis, the Y axis and the Z axis, and “−” is given to a direction opposite thereto.

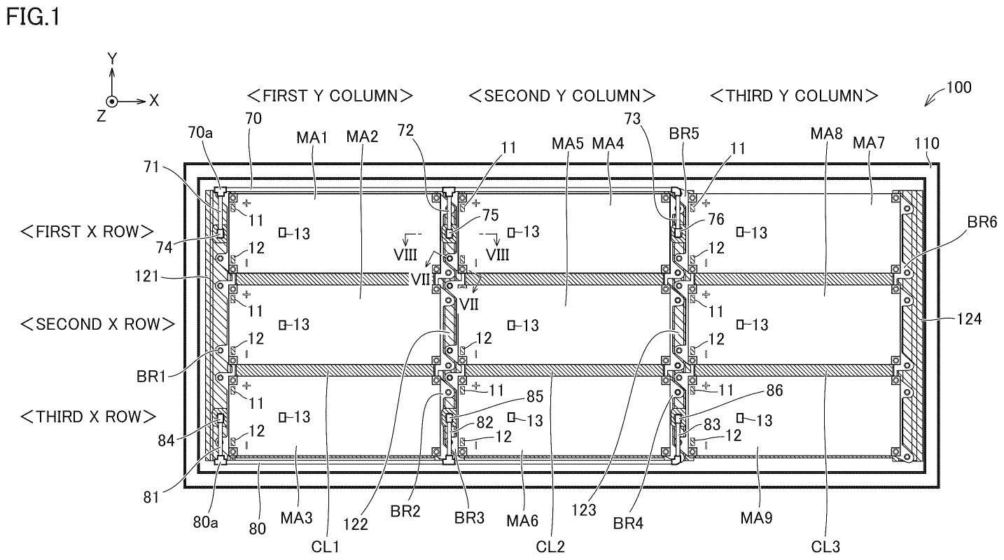

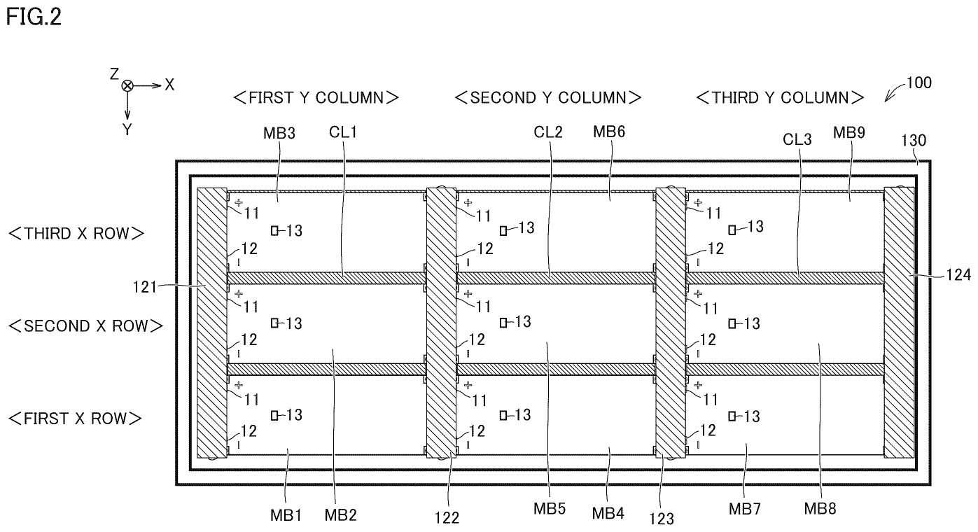

A schematic configuration of a power storage device according to the present embodiment will be described below with reference to FIGS. 1 and 2. FIG. 1 is a diagram of the inside of the power storage device when viewed from the +Z side (upper side). In FIG. 1, a UPR (upper) case is not shown. FIG. 2 is a diagram of the inside of the power storage device when viewed from the −Z side (lower side). In FIG. 2, a LWR (lower) case is not shown.

Referring to FIGS. 1 and 2, a power storage device 100 according to the present embodiment is, for example, a battery pack. Power storage device 100 includes a LWR case 110, cross members 121 to 124, and a UPR case 130, and these components constitute a case of the battery pack. Each of cross members 121 to 124 is a cross member formed to be elongated in a Y direction, and is fixed (e.g., fastened) to LWR case 110. Each of cross members 121 to 124 may be a plate-like member processed into an arbitrary shape (e.g., a member formed by bending a metallic plate-like member to have a U shape). Cross members 121 to 124 are battery crosses that constitute a frame of the battery pack.

Power storage device 100 further includes power storage modules MA1 to MA9 and MB1 to MB9, coolers CL1 to CL3, and brackets BR1 to BR6, and these components are accommodated in the case.

As shown in FIGS. 1 and 2, in power storage device 100, eighteen power storage modules are disposed in a matrix with three rows (a first X row, a second X row and a third X row) in an X direction and three columns (a first Y column, a second Y column and a third Y column) in the Y direction on each of the +Z side (upper side) and the −Z side (lower side) of coolers CL1 to CL3.

The first Y column on the +Z side includes power storage modules MA1 to MA3 arranged in the Y direction. The first Y column on the −Z side includes power storage modules MB1 to MB3 arranged in the Y direction. The second Y column on the +Z side includes power storage modules MA4 to MA6 arranged in the Y direction. The second Y column on the −Z side includes power storage modules MB4 to MB6 arranged in the Y direction. The third Y column on the +Z side includes power storage modules MA7 to MA9 arranged in the Y direction. The third Y column on the −Z side includes power storage modules MB7 to MB9 arranged in the Y direction.

The first X row on the +Z side includes power storage modules MA1, MA4 and MA7 arranged in the X direction. The first X row on the −Z side includes power storage modules MB1, MB4 and MB7 arranged in the X direction. The second X row on the +Z side includes power storage modules MA2, MA5 and MA8 arranged in the X direction. The second X row on the −Z side includes power storage modules MB2, MB5 and MB8 arranged in the X direction. The third X row on the +Z side includes power storage modules MA3, MA6 and MA9 arranged in the X direction. The third X row on the −Z side includes power storage modules MB3, MB6 and MB9 arranged in the X direction.

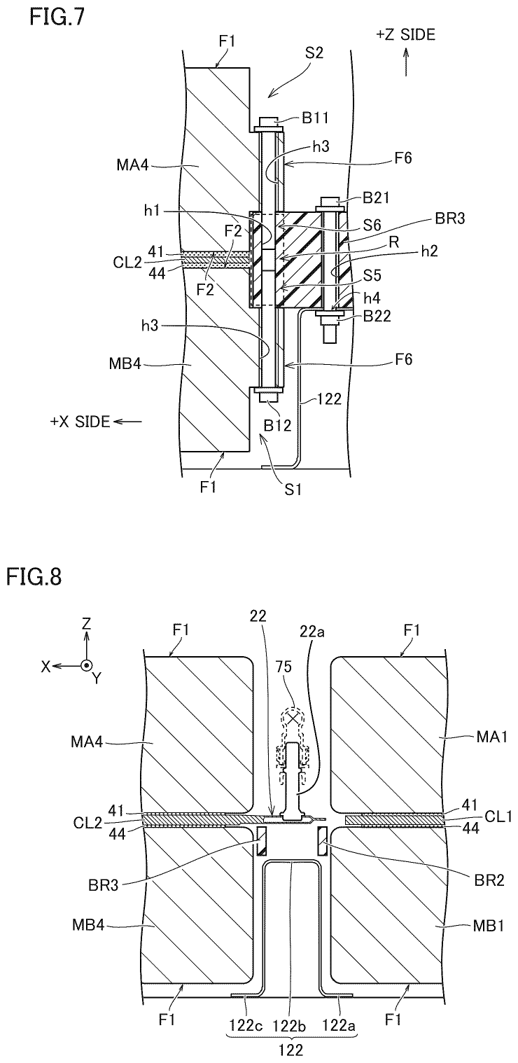

Power storage modules MA1 to MA9 face power storage modules MB1 to MB9 in the Z direction, respectively. Coolers CL1 to CL3 are formed to have a plate shape in an X-Y plane and are disposed at the same position (height) in the Z direction. Power storage modules MA1 to MA9 are located on the +Z side relative to coolers CL1 to CL3. Power storage modules MB1 to MB9 are located on the −Z side relative to coolers CL1 to CL3. Cooler CL1 is configured to cool power storage modules MA1 to MA3 located on the +Z side of cooler CL1 and power storage modules MB1 to MB3 located on the −Z side of cooler CL1. Cooler CL2 is configured to cool power storage modules MA4 to MA6 located on the +Z side of cooler CL2 and power storage modules MB4 to MB6 located on the −Z side of cooler CL2. Cooler CL3 is configured to cool power storage modules MA7 to MA9 located on the +Z side of cooler CL3 and power storage modules MB7 to MB9 located on the −Z side of cooler CL3. Power storage modules MA1 to MA9 and power storage modules MB1 to MB9 are connected through brackets BR1 to BR6 (see FIG. 7 below).

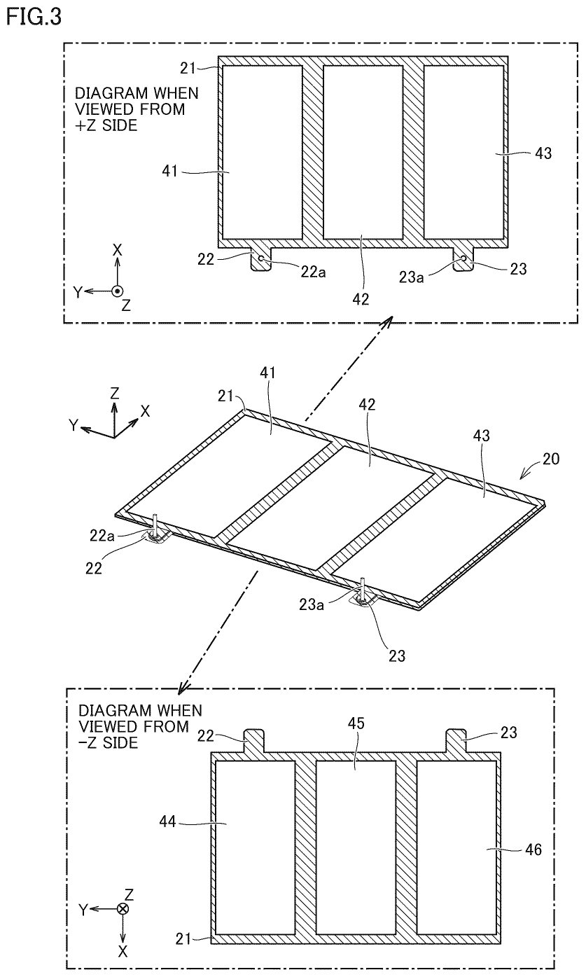

Configurations of each cooler, each bracket and each power storage module will be described in detail below with reference to FIGS. 3 to 6.

FIG. 3 is a diagram showing a cooler having heat conducting members on front and rear surfaces thereof. In the present embodiment, coolers CL1 to CL3 basically have the same configuration. Specifically, a cooler 20 shown in FIG. 3 is adopted as each of coolers CL1 to CL3. By using common cooler 20 to form coolers CL1 to CL3, temperature distribution in power storage device 100 is easily controlled. In addition, manufacturing of power storage device 100 is facilitated and the manufacturing cost can be reduced.

Cooler 20 includes a plate-shaped main body portion 21, cooling ports 22a and 23a, a port support portion 22 that supports cooling port 22a, and a port support portion 23 that supports cooling port 23a. Main body portion 21 has an outer shape of a rectangular plate in the X-Y plane, for example. A surface of main body portion 21 may be flat, or may have a rib. Each of port support portions 22 and 23 protrudes from main body portion 21 to the −X side. Cooling port 22a is a port (refrigerant outlet) through which refrigerant flows out from cooler 20. Port support portion 22 is located on the +Y side relative to the center of main body portion 21 in the Y direction. Cooling port 23a is a port (refrigerant inlet) through which the refrigerant flows into cooler 20. Port support portion 23 is located on the −Y side relative to the center of main body portion 21 in the Y direction. Cooler 20 may be made of metal (e.g., aluminum). Cooler 20 may be an integrally molded component, or may be a composite component of a plurality of separately molded portions (main body portion 21 and port support portions 22 and 23).

Heat conducting members 41, 42 and 43 are provided on an end surface (upper surface) of main body portion 21 on the +Z side (see “diagram when viewed from +Z side”). Heat conducting members 44, 45 and 46 are provided on an end surface (lower surface) of main body portion 21 on the −Z side (see “diagram when viewed from −Z side”). Main body portion 21 includes a first portion located between the power storage modules on the +Z side and the power storage modules on the −Z side included in the first X row, a second portion located between the power storage modules on the +Z side and the power storage modules on the −Z side included in the second X row, and a third portion located between the power storage modules on the +Z side and the power storage modules on the −Z side included in the third X row. Each of heat conducting members 41 and 44 is formed to have such a thickness that a gap between the first portion of main body portion 21 and the power storage modules is filled. Each of heat conducting members 42 and 45 is formed to have such a thickness that a gap between the second portion of main body portion 21 and the power storage modules is filled. Each of heat conducting members 43 and 46 is formed to have such a thickness that a gap between the third portion of main body portion 21 and the power storage modules is filled. Each of heat conducting members 41 to 46 includes a material having a heat conductivity higher than that of air, and has a heat conducting property higher than that of air (air gap). Since the heat conducting members are provided between the power storage modules and cooler 20 in the Z direction, the heat conducting property between the power storage modules and cooler 20 is enhanced. In the present embodiment, heat conducting members 41 to 46 are made of the same material. However, the present disclosure is not limited to such a configuration, and heat conducting members 41 to 46 may be made of different materials.

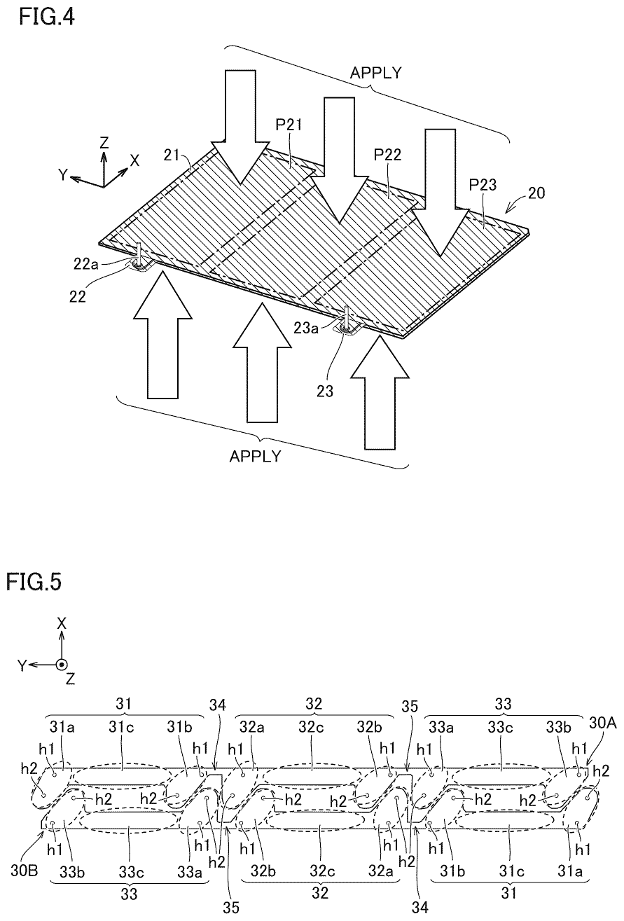

As described above, the heat conducting members are provided on the two end surfaces located at the ends in the Z direction of cooler 20. FIG. 4 is a diagram showing cooler 20 before the heat conducting members are provided. As shown in FIG. 4, paste-like heat conducting members are applied to cooler 20. Specifically, heat conducting members 41 and 44 shown in FIG. 3 are applied to the +Z side and the −Z side of first portion P21 of main body portion 21, respectively. Heat conducting members 42 and 45 shown in FIG. 3 are applied to the +Z side and the −Z side of second portion P22 of main body portion 21, respectively. Heat conducting members 43 and 46 shown in FIG. 3 are applied to the +Z side and the −Z side of third portion P23 of main body portion 21, respectively.

In the present embodiment, each of heat conducting members 41 to 46 includes a paste-like silicone-based material. However, the present disclosure is not limited to such a configuration, and each of heat conducting members 41 to 46 may include any material. For example, each of heat conducting members 41 to 46 may include a non-silicone-based material (e.g., liquid sodium or thermal grease). Another material used in a known thermal interface material (TIM) may be adopted as the material of each of heat conducting members 41 to 46.

As shown in FIG. 1, an −X-side end of each of the power storage modules included in the first Y column is connected to bracket BR1 and is fixed to cross member 121 through bracket BR1. An +X-side end of each of the power storage modules included in the first Y column is connected to bracket BR2 and is fixed to cross member 122 through bracket BR2. An −X-side end of each of the power storage modules included in the second Y column is connected to bracket BR3 and is fixed to cross member 122 through bracket BR3. An +X-side end of each of the power storage modules included in the second Y column is connected to bracket BR4 and is fixed to cross member 123 through bracket BR4. An −X-side end of each of the power storage modules included in the third Y column is connected to bracket BR5 and is fixed to cross member 123 through bracket BR5. An +X-side end of each of the power storage modules included in the third Y column is connected to bracket BR6 and is fixed to cross member 124 through bracket BR6.

In the present embodiment, brackets BR1 to BR6 basically have the same configuration. Since brackets BR1 to BR6 have the same configuration, manufacturing of power storage device 100 is facilitated and the manufacturing cost can be reduced. Each of brackets BR1 to BR6 is made of resin, for example. However, the material of each of brackets BR1 to BR6 can be changed as appropriate. Each bracket may be made of metal.

FIG. 5 is a diagram for illustrating the configuration of each bracket. Each of brackets BR1 to BR6 has the same configuration as that of a bracket 30A or 30B shown in FIG. 5. Although bracket 30A and bracket 30B have the same configuration, one of bracket 30A and bracket 30B is rotated by 180° with respect to the other, with the Z axis being a rotation axis. Each of brackets BR1, BR3 and BR5 is disposed similarly to bracket 30A. Each of brackets BR2, BR4 and BR6 is disposed similarly to bracket 30B. Brackets BR2 and BR3 are a pair of brackets (first facing brackets) that face each other in the X direction, and are fixed to common cross member 122. Brackets BR4 and BR5 are a pair of brackets (second facing brackets) that face each other in the X direction, and are fixed to common cross member 123. Each of the first and second facing brackets are disposed similarly to the facing brackets (brackets 30A and 30B) shown in FIG. 5.

Each of brackets 30A and 30B is formed to be elongated in the Y direction. More specifically, each of brackets 30A and 30B includes holding portions 31 to 33 that hold the power storage modules, a coupling portion 34 that couples holding portion 31 and holding portion 32 to each other in the Y direction, and a coupling portion 35 that couples holding portion 32 and holding portion 33 to each other in the Y direction. Holding portion 31 includes fastening portions 31a and 31b, and a beam portion 31c in the Y direction that connects fastening portion 31a and fastening portion 31b. Holding portion 32 includes fastening portions 32a and 32b, and a beam portion 32c in the Y direction that connects fastening portion 32a and fastening portion 32b. Holding portion 33 includes fastening portions 33a and 33b, and a beam portion 33c in the Y direction that connects fastening portion 33a and fastening portion 33b.

Each of fastening portions 31a, 31b, 32a, 32b, 33a, and 33b includes a proximal end portion located in the vicinity (on the +Y side or −Y side of the beam portion) of the power storage module, and a protruding portion protruding from the proximal end portion to a side away from the power storage module. A hole h1 for fastening the power storage module is formed in the proximal end portion. A hole h2 for fastening the cross member is formed in the protruding portion. Both of hole h1 and hole h2 extend through the bracket in the Z direction. However, hole h1 is a female thread formed in the base member (bracket) and an inner surface of hole h1 is threaded. On the other hand, an inner surface of hole h2 is not threaded and a nut (a nut B22 in FIG. 7 described below) is prepared as a female thread, separately from the bracket.

Six holes h1 formed in the proximal end portions of bracket 30A are arranged in the Y direction. Six holes h1 formed in the proximal end portions of bracket 30B are arranged in the Y direction. The proximal end portions (six holes h1) of bracket 30A and the proximal end portions (six holes h1) of bracket 30B are disposed with a predetermined interval in the X direction.

The protruding portions of bracket 30A and the protruding portions of bracket 30B are disposed to be displaced (offset) by a predetermined amount in the Y direction. Fastening portion 32a of bracket 30A is disposed such that the protruding portion thereof lies between holding portions 32 and 33 of bracket 30B. Fastening portion 33a of bracket 30A is disposed such that the protruding portion thereof lies between holding portions 31 and 32 of bracket 30B. Fastening portion 32a of bracket 30B is disposed such that the protruding portion thereof lies between holding portions 32 and 33 of bracket 30A. Fastening portion 33a of bracket 30B is disposed such that the protruding portion thereof lies between holding portions 31 and 32 of bracket 30A. Six holes h2 formed in bracket 30A and six holes h2 formed in bracket 30B (a total of twelve holes h2) are arranged in the Y direction.

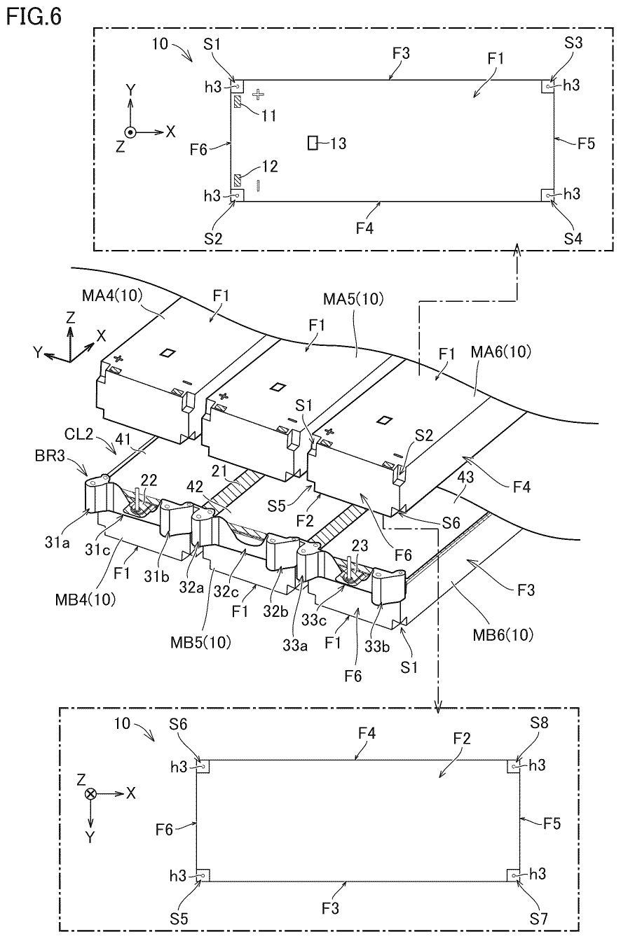

In the present embodiment, power storage modules MA1 to MA9 and MB1 to MB9 basically have the same configuration. Specifically, a power storage module (hereinafter, denoted as “MDL”) 10 shown in FIG. 6 is adopted as each of power storage modules MA1 to MA9 and MB1 to MB9. By using common MDL 10 to form power storage modules MA1 to MA9 and MB1 to MB9, manufacturing of power storage device 100 is facilitated and the manufacturing cost can be reduced. FIG. 6 is a diagram for illustrating a configuration of each power storage module.

MDL 10 has a rectangular parallelepiped outer shape. MDL 10 has surfaces F1 and F2 facing each other in the Z direction, surfaces F3 and F4 facing each other in the Y direction, and surfaces F5 and F6 facing each other in the X direction. Steps S1 to S8 are formed at eight corners of MDL 10. Step S1 is located at the corner where surfaces F1, F3 and F6 meet. Step S2 is located at the corner where surfaces F1, F4 and F6 meet. Step S3 is located at the corner where surfaces F1, F3 and F5 meet. Step S4 is located at the corner where surfaces F1, F4 and F5 meet. Step S5 is located at the corner where surfaces F2, F3 and F6 meet. Step S6 is located at the corner where surfaces F2, F4 and F6 meet. Step S7 is located at the corner where surfaces F2, F3 and F5 meet. Step S8 is located at the corner where surfaces F2, F4 and F5 meet.

A hole h3 extending through MDL 10 in the Z direction is formed in each of steps S1 to S4. Hole h3 formed in step S1 reaches step S5 that is opposite to step S1. Hole h3 formed in step S2 reaches step S6 that is opposite to step S2. Hole h3 formed in step S3 reaches step S7 that is opposite to step S3. Hole h3 formed in step S4 reaches step S8 that is opposite to step S4. An inner surface of hole h3 is not threaded. Above-described hole h1 (FIG. 5) functions as a female thread with respect to a bolt (male thread) extending through hole h3. A diameter of hole h3 is the same as or larger than a diameter of hole h1. A recessed portion (counterbore) that accommodates a bolt head or a washer may be formed in the vicinity of hole h3 formed in each of steps S1 to S8.

MDL 10 is configured to be capable of storing electric power. Specifically, MDL 10 includes a power storage portion (not shown) that stores electric power. The power storage portion of MDL 10 may include a secondary battery such as a lithium ion battery, a nickel-metal hydride battery or a sodium ion battery, for example. Examples of the lithium ion battery include an LFP battery in which lithium ferrous phosphate is adopted as a positive electrode active material, and a ternary battery in which NMC (nickel manganese cobalt) is adopted as a positive electrode active material. The type of the secondary battery may be a liquid-type secondary battery, or may be an all-solid-state secondary battery. One secondary battery may be included in MDL 10, or a plurality of secondary batteries may be included in MDL 10. The power storage portion of MDL 10 may include an assembled battery configured by electrically connecting a plurality of secondary batteries (cells). The power storage portion of MDL 10 may include only the cells of the same type (e.g., only the ternary batteries), or may include the cells of different types (e.g., the LFP batteries and the ternary batteries). Each of the cells may be a laminate cell having one or more wound bodies.

An end portion of MDL 10 on the surface F1 side further includes a positive electrode terminal 11, a negative electrode terminal 12 and an exhaust device 13. Positive electrode terminal 11 and negative electrode terminal 12 are used to apply a voltage to the power storage portion of MDL 10 or extract electric power from the power storage portion of MDL 10. MDL 10 may be electrically connected to another device (including another power storage module) through positive electrode terminal 11 and negative electrode terminal 12. A plurality of MDLs 10 included in power storage device 100 may be connected in series or in parallel. Through positive electrode terminal 11 and negative electrode terminal 12, power storage device 100 may be electrically connected to an external device that receives power supply from power storage device 100. Exhaust device 13 is configured to discharge gas (e.g., fumes) from the power storage portion of MDL 10. Exhaust device 13 includes an exhaust valve that is opened when an internal pressure of the power storage portion of MDL 10 rises, for example. Exhaust device 13 may include any number of exhaust valves. For example, when MDL 10 includes a plurality of cells (secondary batteries), the exhaust valve may be provided for each cell. Exhaust device 13 may further include a not-shown exhaust path (e.g., a notch or a duct). The fumes generated in the power storage portion of MDL 10 may be guided to the outside of power storage device 100 through the exhaust path. In the present embodiment, positive electrode terminal 11, negative electrode terminal 12 and exhaust device 13 are provided at only one end portion (end portion on the surface F1 side) of two end portions in the Z direction of MDL 10. In the present embodiment, each of positive electrode terminal 11, negative electrode terminal 12 and exhaust device 13 corresponds to an example of “first target component” according to the present disclosure. In addition, the Z direction, the X direction and the Y direction correspond to examples of “first direction”, “second direction” and “third direction” according to the present disclosure, respectively.

The power storage module has components other than the power storage portion (e.g., the battery). Some components may malfunction when the components are cooled excessively. However, when the cooling capability of the cooler is decreased to protect these components, cooling of the other portions (e.g., the power storage portion) of the power storage module may become insufficient. Thus, in power storage device 100 according to the present embodiment, a plurality of power storage modules are disposed in an orientation described below. As a result, the power storage device including the plurality of power storage modules can be cooled efficiently and appropriately.

As shown in FIG. 6, a part of cooler CL2 (the first portion of main body portion 21) is located between power storage module MA4 and power storage module MB4 in the Z direction. A part of cooler CL2 (the second portion of main body portion 21) is located between power storage module MA5 and power storage module MB5 in the Z direction. A part of cooler CL2 (the third portion of main body portion 21) is located between power storage module MA6 and power storage module MB6 in the Z direction.

Power storage modules MA4 to MA6 and power storage modules MB4 to MB6 are disposed in an inverted orientation with respect to cooler CL2. Specifically, MDL 10 that constitutes each of power storage modules MB4 to MB6 is rotated by 180° with respect to MDL 10 that constitutes each of power storage modules MA4 to MA6, with the X axis being a rotation axis. Each of power storage modules MA4 to MA6 is disposed such that surface F1 (the end portion including the first target component) faces away from cooler CL2 (+Z side). That is, each of power storage modules MA4 to MA6 is disposed such that surface F2 faces cooler CL2 (−Z side). Heat conducting members 41 to 43 are provided between power storage modules MA4 to MA6 and cooler CL2 in the Z direction, respectively. Each of power storage modules MB4 to MB6 is disposed such that surface F1 (the end portion including the first target component) faces away from cooler CL2 (−Z side). That is, each of power storage modules MB4 to MB6 are disposed such that surface F2 faces cooler CL2 (+Z side). Heat conducting members 44 to 46 (FIG. 3) are provided between power storage modules MB4 to MB6 and cooler CL2 in the Z direction, respectively. Each of power storage modules MA4 to MA6 and MB4 to MB6 is fixed to bracket BR3.

Although FIG. 6 representatively shows only power storage modules MA4 to MA6 and MB4 to MB6, power storage modules MA1 to MA3 and MB1 to MB3, and power storage modules MA7 to MA9 and MB7 to MB9 are also disposed with respect to coolers CL1 and CL3 in the manner shown in FIG. 6, respectively.

FIG. 7 is a cross-sectional view taken along line VII-VII in FIG. 1. As shown in FIGS. 1 and 7, cooler CL2 and bracket BR3 are disposed to be arranged in the X direction. A recessed portion R into which a part of bracket BR3 is inserted is formed in the end surface (surface F6) of power storage module MA4 on the −X side and the end surface (surface F6) of power storage module MB4 on the −X side. Specifically, the corner (step S6) of power storage module MA4 on the −Z side and the corner (step S5) of power storage module MB4 on the +Z side form recessed portion R. Recessed portion R is opened toward the −X side.

The portion (the proximal end portion of fastening portion 31b shown in FIG. 5) of bracket BR3 inserted into recessed portion R is provided with hole h1 (female thread) extending through the portion in the Z direction. In the X-Y plane, hole h3 (step S2) of power storage module MA4, hole h3 (step S1) of power storage module MB4, and hole h1 of bracket BR3 are disposed at the same position. A bolt B11 (first bolt) is inserted from the +Z side into hole h3 extending through power storage module MA4 from step S2 to step S6, passes through hole h3 and is screwed into hole h1.

Bolt B11 fastens power storage module MA4 to bracket BR3. In addition, a bolt B12 (second bolt) is inserted from the −Z side into hole h3 extending through power storage module MB4 from step S1 to step S5, passes through hole h3 and is screwed into hole h1. Bolt B12 fastens power storage module MB4 to bracket BR3.

Step S2 (first step) is formed in surface F1 (the end surface opposite to cooler CL2 in the Z direction) of power storage module MA4. Bolt B11 extends through a portion of power storage module MA4 having a thickness reduced by step S2. In addition, step S1 (second step) is formed in surface F1 (the end surface opposite to cooler CL2 in the Z direction) of power storage module MB4. Bolt B12 extends through a portion of power storage module MB4 having a thickness reduced by step S1. Such a configuration makes it easy to adopt a short bolt as each of bolts B11 and B12. By fastening using the short bolt, the fastening becomes hard to loosen.

In the present embodiment, the paste-like heat conducting members are applied to the two end surfaces located at the ends in the Z direction of cooler CL2 (see FIGS. 3 and 4). Heat conducting member 41 (first heat conducting member) is provided between surface F2 of power storage module MA4 and cooler CL2. Heat conducting member 44 (second heat conducting member) is provided between surface F2 of power storage module MB4 and cooler CL2. Each power storage module, each cooler and each bracket are all rigid components. In contrast, each heat conducting member is a flexible material. By tightening each of bolts B11 and B12 to a position where each of bolts B11 and B12 is seated, heat conducting members 41 and 44 are compressed and the thicknesses of heat conducting members 41 and 44 are adjusted to a predetermined thickness. The predetermined thickness is determined by a depth of step S6 of power storage module MA4, a depth of step S5 of power storage module MB4, and a thickness of bracket BR3. Therefore, control of the thicknesses of heat conducting members 41 and 44 provided on both surfaces of cooler CL2 becomes easy. In addition, by fastening power storage modules MA4 and MB4 to bracket BR3 from both sides in the Z direction of bracket BR3, the thickness of heat conducting member 41 and the thickness of heat conducting member 44 can be easily made equal.

Bracket BR3 is fastened to cross member 122 and is fixed to LWR case 110 (FIG. 1) through cross member 122. Specifically, a hole h4 is formed in cross member 122 (more particularly, a portion 122b in FIG. 8 described below). In the X-Y plane, hole h2 formed in bracket BR3 (more particularly, the protruding portion of fastening portion 31b shown in FIG. 5) and hole h4 of cross member 122 are disposed at the same position. A bolt B21 is inserted into hole h2 from the +Z side, passes through holes h2 and h4, and is screwed into nut B22 (female thread) provided on the −Z side of cross member 122. Bracket BR3 and cross member 122 are sandwiched between a head of bolt B21 and nut B22.

Although FIG. 7 representatively shows only the connection structure between each of power storage modules MA4 and MB4 and bracket BR3, bracket BR3 is also connected to the other power storage modules (power storage modules MA5, MB5, MA6, and MB6) included in the second Y column by the same structure. A connection structure between each of the power storage modules included in the second Y column and bracket BR4 is also the same as the connection structure shown in FIG. 7. Furthermore, connection structures between each of the power storage modules included in the first Y column and brackets BR1 and BR2, and connection structures between each of the power storage modules included in the third Y column and brackets BR5 and BR6 are also the same as the structure shown in FIG. 7.

Referring again to FIGS. 1 and 2, each of brackets BR1 and BR2 is configured to hold power storage modules MA1 to MA3 and MB1 to MB3. Cooler CL1 has a portion located between power storage module MA1 and power storage module MB1 in the Z direction, a portion located between power storage module MA2 and power storage module MB2 in the Z direction, and a portion located between power storage module MA3 and power storage module MB3 in the Z direction. Cooling port 22a (FIG. 3) of cooler CL1 is connected to a joint 74. Joint 74 is connected to a flow path 71 (e.g., a pipe) extending in the Y direction. Joint 74 is connected to a flow path 70 (e.g., a pipe) through flow path 71. Flow path 70 is located on the +Y side relative to the first X row and causes the refrigerant to flow in the X direction. Flow path 71 causes joint 74 and flow path 70 to communicate with each other and causes the refrigerant flowing out through cooling port 22a of cooler CL1 to flow to flow path 70. In addition, cooling port 23a (FIG. 3) of cooler CL1 is connected to a joint 84. Joint 84 is connected to a flow path 81 (e.g., a pipe) extending in the Y direction. Joint 84 is connected to a flow path 80 (e.g., a pipe) through flow path 81. Flow path 80 is located on the −Y side relative to the third X row and causes the refrigerant to flow in the X direction. Flow path 81 causes joint 84 and flow path 80 to communicate with each other and causes the refrigerant flowing through flow path 80 to flow into cooling port 23a of cooler CL1. In cooler CL1, a direction in which power storage modules MA1 to MA3 are arranged, a direction in which power storage modules MB1 to MB3 are arranged, and a direction in which cooling port 22a (joint 74) and cooling port 23a (joint 84) are arranged are the same, i.e., the Y direction.

Each of brackets BR3 and BR4 is configured to hold power storage modules MA4 to MA6 and MB4 to MB6. Cooler CL2 has a portion located between power storage module MA4 and power storage module MB4 in the Z direction, a portion located between power storage module MA5 and power storage module MB5 in the Z direction, and a portion located between power storage module MA6 and power storage module MB6 in the Z direction. Cooling port 22a (FIG. 3) of cooler CL2 is connected to a joint 75. Joint 75 is connected to a flow path 72 (e.g., a pipe) extending in the Y direction. Joint 75 is connected to flow path 70 through flow path 72. Flow path 72 causes joint 75 and flow path 70 to communicate with each other and causes the refrigerant flowing out through cooling port 22a of cooler CL2 to flow to flow path 70. In addition, cooling port 23a (FIG. 3) of cooler CL2 is connected to a joint 85. Joint 85 is connected to a flow path 82 (e.g., a pipe) extending in the Y direction. Joint 85 is connected to flow path 80 through flow path 82. Flow path 82 causes joint 85 and flow path 80 to communicate with each other and causes the refrigerant flowing through flow path 80 to flow into cooling port 23a of cooler CL2. In cooler CL2, a direction in which power storage modules MA4 to MA6 are arranged, a direction in which power storage modules MB4 to MB6 are arranged, and a direction in which cooling port 22a (joint 75) and cooling port 23a (joint 85) are arranged are the same, i.e., the Y direction.

Each of brackets BR5 and BR6 is configured to hold power storage modules MA7 to MA9 and MB7 to MB9. Cooler CL3 has a portion located between power storage module MA7 and power storage module MB7 in the Z direction, a portion located between power storage module MA8 and power storage module MB8 in the Z direction, and a portion located between power storage module MA9 and power storage module MB9 in the Z direction. Cooling port 22a (FIG. 3) of cooler CL3 is connected to a joint 76. Joint 76 is connected to a flow path 73 (e.g., a pipe) extending in the Y direction. Joint 76 is connected to flow path 70 through flow path 73. Flow path 73 causes joint 76 and flow path 70 to communicate with each other and causes the refrigerant flowing out through cooling port 22a of cooler CL3 to flow to flow path 70. In addition, cooling port 23a (FIG. 3) of cooler CL3 is connected to a joint 86. Joint 86 is connected to a flow path 83 (e.g., a pipe) extending in the Y direction. Joint 86 is connected to flow path 80 through flow path 83. Flow path 83 causes joint 86 and flow path 80 to communicate with each other and causes the refrigerant flowing through flow path 80 to flow into cooling port 23a of cooler CL3. In cooler CL3, a direction in which power storage modules MA7 to MA9 are arranged, a direction in which power storage modules MB7 to MB9 are arranged, and a direction in which cooling port 22a (joint 76) and cooling port 23a (joint 86) are arranged are the same, i.e., the Y direction.

As described above, cooling port 23a of cooler CL1, cooling port 23a of cooler CL2, and cooling port 23a of cooler CL3 are connected to common flow path 80 (first flow path). In addition, cooling port 22a of cooler CL1, cooling port 22a of cooler CL2, and cooling port 22a of cooler CL3 are connected to common flow path 70 (second flow path). In the present embodiment, cooling port 23a of cooler CL2, cooling port 22a of cooler CL2, cooling port 23a of cooler CL1, and cooling port 22a of cooler CL1 correspond to examples of “first cooling port”, “second cooling port”, “third cooling port”, and “fourth cooling port” according to the present disclosure, respectively. In addition, power storage module MA4, power storage module MB4, power storage module MA1, and power storage module MB1 correspond to examples of “first power storage module”, “second power storage module”, “third power storage module”, and “fourth power storage module” according to the present disclosure, respectively. In addition, cooler CL2, cooler CL1, bracket BR3, and bracket BR2 correspond to examples of “first cooler”, “second cooler”, “first bracket”, and “second bracket” according to the present disclosure, respectively.

FIG. 8 is a cross-sectional view taken along line VIII-VIII in FIG. 1. As shown in FIGS. 1 and 8, port support portion 22 of cooler CL2 is provided to overlap with cross member 122 in the Z direction. Specifically, cross member 122 has a portion 122a located on the −Z side (the side opposite to cooler CL1 in the Z direction) of power storage module MB1, a portion 122b protruding to the +Z side (the port support portion 22 side of cooler CL2) between power storage module MB4 and power storage module MB1, and a portion 122c located on the −Z side (the side opposite to cooler CL2 in the Z direction) of power storage module MB4. Port support portion 22 is provided in the portion where cross member 122 having high rigidity is provided, and thus, the rigidity of port support portion 22 and the surroundings thereof is reinforced. In addition, port support portion 22 has a hollow structure. Since a cavity is formed inside port support portion 22, any impact is easily absorbed.

Port support portion 22 of cooler CL2 protrudes from between power storage module MA4 and power storage module MB4 to the −X side (the cooler CL1 side). Cooling port 22a of cooler CL2 is located between power storage module MA4 and power storage module MA1. Cooling port 22a of cooler CL2 is provided such that displacement in the Z direction (more particularly, displacement on the −Z side) is suppressed by brackets BR2 and BR3. In the present embodiment, port support portion 22 of cooler CL2 is not in contact with brackets BR2 and BR3. As shown in FIG. 6, beam portion 31c of bracket BR3 is located in the vicinity of port support portion 22 of cooler CL2 on the −Z side. In addition, beam portion 33c (FIG. 5) of bracket BR2 is disposed at the same height (position in the Z direction) as that of beam portion 31c of bracket BR3. Each of beam portions 31c and 33c is formed to have a U shape in a Y-Z plane (see FIG. 6). When the −Z-side force (load) is applied to port support portion 22 of cooler CL2 and port support portion 22 is pushed to the −Z side, port support portion 22 hits brackets BR2 and BR3. Brackets BR2 and BR3 support port support portion 22 in the manner of a both-end-supported beam, to suppress displacement of port support portion 22 and cooling port 22a to the −Z side. Therefore, damage to port support portion 22 and cooling port 22a caused by the external force can be suppressed. For example, deformation of port support portion 22 caused by the load applied to cooling port 22a during joint assembly is suppressed. Port support portion 22 of cooler CL2 may be in contact with at least one of brackets BR2 and BR3 in a state where no force is applied.

Although FIG. 8 representatively shows only the support structure of cooling port 22a of cooler CL2, the other cooling ports (cooling port 23a of cooler CL2, cooling port 22a of cooler CL3 and cooling port 23a of cooler CL3) disposed between the power storage modules are also supported by the same structure.

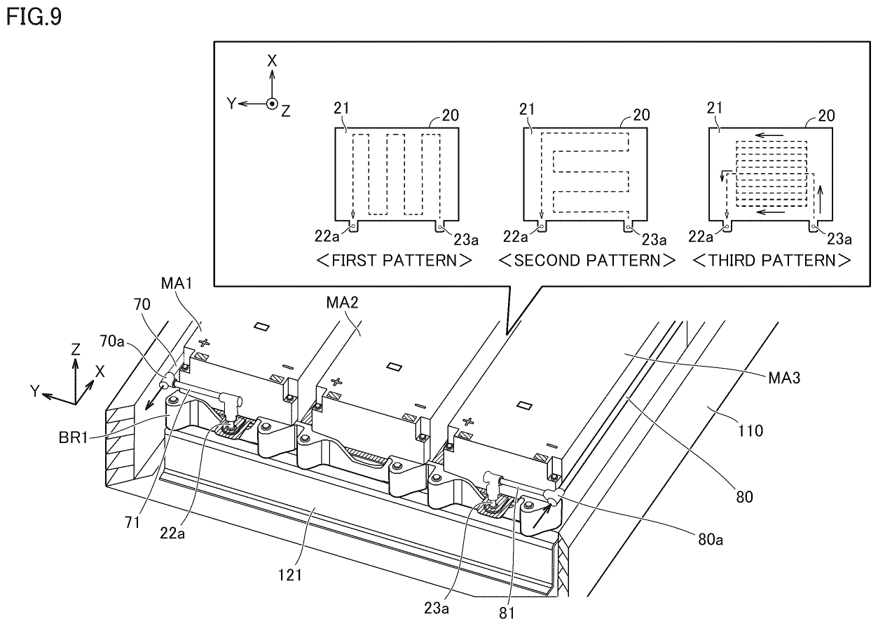

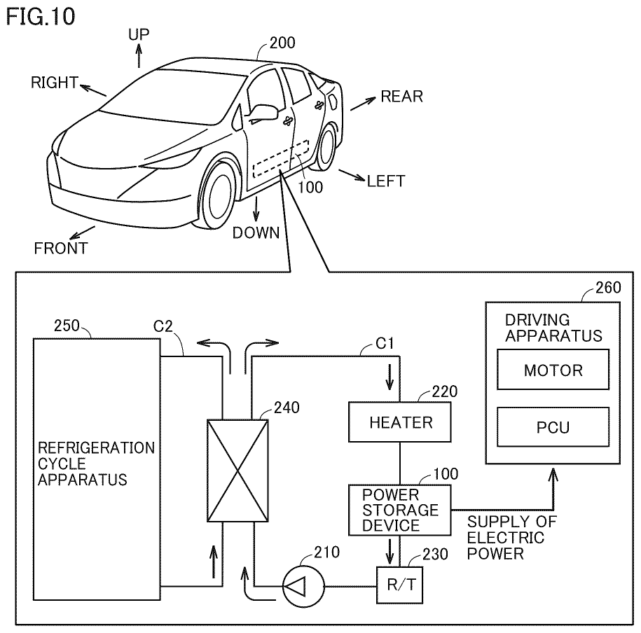

FIG. 9 is a diagram showing an end portion of power storage device 100 on the −X side. In FIG. 9, a part of the case is omitted such that the inside of the case can be seen. Referring to FIGS. 1 and 9, a T-type joint 70a connected to flow paths 70 and 71 is provided at a −X-side end of flow path 70. T-type joint 70a further has a first connection port, in addition to ports connected to flow paths 70 and 71. Furthermore, a T-type joint 80a connected to flow paths 80 and 81 is provided at a −X-side end of flow path 80. T-type joint 80a further has a second connection port, in addition to ports connected to flow paths 80 and 81. By connecting a refrigerant circuit (e.g., a refrigerant circuit C1 in FIG. 10 described below) including a pump to the first connection port (T-type joint 70a) and the second connection port (T-type joint 80a), it is possible to supply the refrigerant from flow path 80 to each of coolers CL1 to CL3, and cause the refrigerant flowing out from cooler CL1, the refrigerant flowing out from cooler CL2 and the refrigerant flowing out from cooler CL3 to flow through flow path 70 together. By circulating the refrigerant in each of coolers CL1 to CL3 using the pump, power storage modules MA1 to MA9 and MB1 to MB9 can be continuously cooled. The refrigerant may be a liquid (e.g., water or an antifreeze), or may be a gas (e.g., a carbon dioxide gas).

FIG. 9 illustrates three patterns about a refrigerant path formed in main body portion 21 of each of coolers CL1 to CL3. The refrigerant path is a path through which the refrigerant flows and is formed inside main body portion 21 of cooler 20. The refrigerant flowing through main body portion 21 of cooler 20 exchanges heat with each of the plurality of power storage modules provided in cooler 20. The refrigerant path is formed such that the refrigerant exchanges heat with the whole or most of main body portion 21. In a first pattern, the flow path is formed such that the refrigerant flows to the +Y side while reciprocating in the X direction. In a second pattern, the flow path is formed such that the refrigerant flows to the +X side while reciprocating in the Y direction. In a third pattern, the flow path is formed such that the refrigerant flows through a plurality of branch paths to the +Y side simultaneously. However, the refrigerant path in each cooler is not limited to these patterns and can be set arbitrarily.

Power storage device 100 having the above-described configuration can be cooled efficiently and appropriately. Specifically, each of coolers CL1 to CL3 is configured to cool the power storage modules disposed on both sides in the Z direction. This makes it easy to efficiently cool power storage device 100 using coolers CL1 to CL3. In addition, each of power storage modules MA1 to MA9 and MB1 to MB9 is disposed such that the end portion including positive electrode terminal 11, negative electrode terminal 12 and exhaust device 13 faces away from the cooler. Therefore, excessive cooling (and thus, a malfunction due to dew condensation) of positive electrode terminal 11, negative electrode terminal 12 and exhaust device 13 can be suppressed.

Power storage device 100 described above may be mounted on a mobile body, for example. Examples of the mobile body include automobiles (such as electric vehicles and hybrid vehicles), vehicles other than automobiles (such as ships and airplanes), mobile machines (such as agricultural machines and construction machines), and unmanned mobile bodies (such as automated guided vehicles and robots). However, the power storage device is applicable to any application, and may be applied to stationary application.

FIG. 10 is a diagram showing an example of a vehicle on which power storage device 100 is mounted. A vehicle 200 shown in FIG. 10 includes power storage device 100. FIG. 10 shows an up-down direction, a front-rear direction and a left-right direction that are orthogonal to one another. “Down” corresponds to the vertical direction (direction of gravity) and “up” corresponds to a direction opposite thereto. Power storage device 100 is mounted on vehicle 200 in a state where a −Z-side surface faces downward and a −X-side surface faces frontward, for example.

Vehicle 200 includes refrigerant circuits C1 and C2, a chiller 240 and a driving apparatus 260. Refrigerant circuit C1 includes a pump 210, a heater 220 and a reserve tank (R/T) 230. Pump 210 circulates the refrigerant through refrigerant circuit C1. Heater 220 heats the refrigerant flowing through refrigerant circuit C1, in response to a request from a not-shown controller (e.g., an on-board computer). The refrigerant flowing through refrigerant circuit C1 cools power storage device 100 when the temperature of power storage device 100 rises. However, when the temperature of power storage device 100 is low due to the weather, location (e.g., cold region) or the like, the refrigerant heated by heater 220 may raise the temperature of power storage device 100. Refrigerant circuit C2 includes a refrigeration cycle apparatus 250. Refrigeration cycle apparatus 250 includes various devices that perform temperature adjustment through a refrigeration cycle (i.e., a cycle including an evaporation stroke, a compression stroke, a condensation stroke, and an expansion stroke). A cooling circuit of an air conditioner mounted on vehicle 200 may constitute refrigeration cycle apparatus 250. The refrigerant flowing through refrigerant circuit C2 is cooled by refrigeration cycle apparatus 250. Chiller 240 is connected to refrigerant circuits C1 and C2 to perform heat exchange between the refrigerant circulating through refrigerant circuit C1 and the refrigerant circulating through refrigerant circuit C2.

Vehicle 200 is, for example, an electric vehicle configured to be capable of traveling using electric power output from power storage device 100. Using electric power supplied from power storage device 100, driving apparatus 260 generates motive power for causing vehicle 200 to travel. Driving apparatus 260 includes, for example, a motor that rotates a driving wheel of vehicle 200, and a power control unit (PCU). The PCU is a circuit that drives the motor using electric power from power storage device 100, and includes an inverter, for example. Power storage device 100 may be placed on the floor of vehicle 200, or may be placed under the floor of vehicle 200. Power storage device 100 mounted on vehicle 200 may have a packless structure. Instead of cross members 121 to 124 (battery crosses) provided in LWR case 110, a cross member (floor cross) provided on a floor panel of vehicle 200 may be adopted. The cross member may function as an EA member.

When a combination of a cooler and two power storage modules cooled by the cooler is defined as one unit (hereinafter, referred to as “stacked unit”), power storage device 100 includes nine stacked units. In each of the stacked units, the cooler is located between the two power storage modules in the Z direction, and each of these two power storage modules is disposed such that an end portion on the surface F1 side (an end portion including a first target component) faces away from the cooler. The number of the stacked units in the power storage device can be changed as appropriate. The number of the stacked units may be one, may be equal to or more than two and equal to or less than eight, may be equal to or more than ten and less than thirty, or may be equal to or more than thirty.

In power storage device 100, a plurality of stacked units are arranged in each of the X direction and the Y direction. However, power storage device 100 does not include a plurality of stacked units arranged in the Z direction. However, the present disclosure is not limited to such a configuration, and a stacked unit may be added to the Z direction of any one of the stacked units included in power storage device 100.

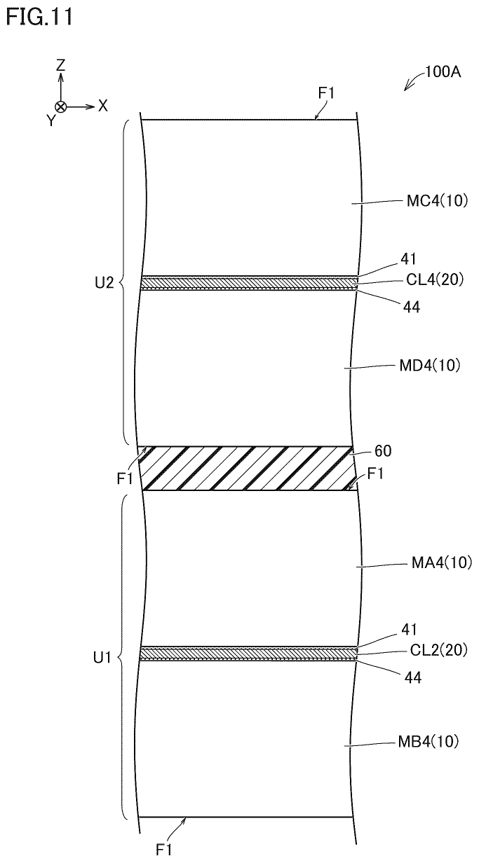

FIG. 11 is a diagram showing a power storage device according to a first modification. Referring to FIG. 11, a power storage device 100A includes a plurality of stacked units arranged in the Z direction. A stacked unit U1 corresponds to the stacked unit shown in FIG. 1, and specifically a combination of cooler CL2 and power storage modules MA4 and MB4 cooled by cooler CL2. Cooler CL2 has the configuration shown in FIG. 3. In power storage device 100A, a spacer 60 and a stacked unit U2 are added to power storage device 100. Spacer 60 is provided between stacked unit U1 and stacked unit U2 in the Z direction. Spacer 60 may function as an exhaust duct. Stacked unit U2 includes a cooler CL4 and power storage modules MC4 and MD4 cooled by cooler CL4. Each of power storage modules MC4 and MD4 is formed by MDL 10 shown in FIG. 6, for example. Cooler CL4 has the configuration shown in FIG. 3, for example. However, the configuration of cooler CL4 can be changed as appropriate.

In power storage device 100A shown in FIG. 11, a stacked unit is added to the +Z side of power storage module MA4 in power storage device 100. Similarly, a stacked unit may also be added to the +Z side of at least one of power storage modules MA1 to MA3 and MA5 to MA9 in power storage device 100.

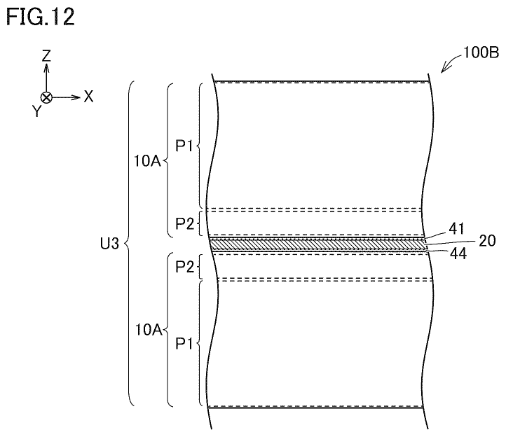

The configuration of the stacked unit is not limited to the above-described configuration. For example, in the stacked unit, each of the two power storage modules cooled by the cooler may have a configuration different from that of MDL 10 shown in FIG. 6. FIG. 12 is a diagram showing a power storage device according to a second modification. Referring to FIG. 12, a power storage device 100B includes a stacked unit U3. Stacked unit U3 includes cooler 20 and two power storage modules 10A cooled by cooler 20. Cooler 20 is located between two power storage modules 10A. Each of power storage modules 10A includes a power storage portion P1 and a heat generation portion P2. Heat generation portion P2 includes a component (second target component) that generates heat during charging or discharging of power storage module 10A. Examples of such a component include a resistance element through which a current flows during charging or discharging of power storage portion P1, and a circuit board used for charging control and/or discharging control in power storage portion P1. In stacked unit U3, each of two power storage modules 10A cooled by cooler 20 is disposed such that an end portion including heat generation portion P2, of two end portions in the Z direction, faces cooler 20. Since heat generation portion P2 of each power storage module is disposed on the cooler 20 side, heat generation portion P2 of each power storage module can be preferentially cooled by cooler 20. Power storage device 100B may include a plurality of stacked units U3. For example, nine stacked units U3 may be disposed as shown in FIGS. 1 and 2.

The configuration of each power storage module is not limited to the configuration shown in FIG. 6. In power storage device 100, power storage modules MA1 to MA9 and MB1 to MB9 may have different configurations. The configuration of each cooler is not limited to the configuration shown in FIG. 3. The shape of each cooler can be changed as appropriate. In power storage device 100, coolers CL1 to CL3 may have different configurations. It is not essential that the heat conducting members should be provided on the surface of the cooler, and the heat conducting members may be omitted. The configuration of each bracket is not limited to the configuration shown in FIG. 5. The shape of each bracket can be changed as appropriate. In power storage device 100, brackets BR1 to BR6 may have different configurations.

Various features about the power storage device described above (features described in the embodiment and the modifications) may be arbitrarily combined and applied. The power storage device may be applied to an apparatus other than the vehicle.

Although the embodiment of the present disclosure has been described, it should be understood that the embodiment disclosed herein is illustrative and non-restrictive in every respect. The scope of the present disclosure is defined by the terms of the claims, and is intended to include any modifications within the scope and meaning equivalent to the terms of the claims.

What is claimed is:

1. A power storage device comprising:
a first power storage module and a second power storage module arranged in a first direction; and
a first cooler located between the first power storage module and the second power storage module, wherein
each of the first power storage module and the second power storage module includes a first target component at only one end portion of two end portions in the first direction, and
each of the first power storage module and the second power storage module is disposed such that the end portion including the first target component faces away from the first cooler.

2. The power storage device according to claim 1, wherein
the first target component included in the first power storage module includes at least one of an exhaust valve of the first power storage module, a positive electrode terminal of the first power storage module, and a negative electrode terminal of the first power storage module, and
the first target component included in the second power storage module includes at least one of an exhaust valve of the second power storage module, a positive electrode terminal of the second power storage module, and a negative electrode terminal of the second power storage module.

3. The power storage device according to claim 1, wherein
the first power storage module and the second power storage module have the same configuration.

4. The power storage device according to claim 1, wherein
a first heat conducting member is provided between the first power storage module and the first cooler in the first direction, and
a second heat conducting member is provided between the second power storage module and the first cooler in the first direction.

5. The power storage device according to claim 1, further comprising a first bracket, wherein
each of the first power storage module and the second power storage module is fixed to the first bracket.

6. The power storage device according to claim 5, wherein
the first cooler and the first bracket are disposed to be arranged in a second direction orthogonal to the first direction, and
a recessed portion into which the first bracket is inserted is formed in an end surface in the second direction of each of the first power storage module and the second power storage module.

7. The power storage device according to claim 6, wherein
a portion of the first bracket inserted into the recessed portion is provided with a female thread extending through the portion in the first direction,
a first bolt that fastens the first power storage module to the first bracket is screwed into the female thread, and
a second bolt that fastens the second power storage module to the first bracket is screwed into the female thread.

8. The power storage device according to claim 7, wherein
a first step is formed in an end surface opposite to the first cooler in the first direction of the first power storage module,
the first bolt extends through a portion of the first power storage module having a thickness reduced by the first step,
a second step is formed in an end surface opposite to the first cooler in the first direction of the second power storage module, and
the second bolt extends through a portion of the second power storage module having a thickness reduced by the second step.

9. The power storage device according to claim 7, wherein
paste-like heat conducting members are applied to two end surfaces located at ends in the first direction of the first cooler.

10. The power storage device according to claim 5, further comprising a cross member, wherein
the first bracket is fastened to the cross member.

11. The power storage device according to claim 5, wherein
the first cooler includes a first cooling port through which refrigerant flows into the first cooler, and a second cooling port through which the refrigerant flows out from the first cooler, and
at least one of the first cooling port and the second cooling port is provided such that displacement in the first direction is suppressed by the first bracket.

12. The power storage device according to claim 11, wherein
the first cooler further includes a port support portion that supports the first cooling port or the second cooling port.

13. The power storage device according to claim 12, further comprising a cross member, wherein
the port support portion is provided to overlap with the cross member in the first direction.

14. The power storage device according to claim 13, further comprising:
a third power storage module and a fourth power storage module arranged in the first direction;
a second cooler that cools the third power storage module and the fourth power storage module; and
a second bracket that holds the third power storage module and the fourth power storage module, wherein
at least a part of the second cooler is located between the third power storage module and the fourth power storage module in the first direction,
the first power storage module and the third power storage module are disposed to be arranged in a second direction orthogonal to the first direction,
the second power storage module and the fourth power storage module are disposed to be arranged in the second direction,
the port support portion protrudes from between the first power storage module and the second power storage module toward the second cooler,
the first cooling port or the second cooling port supported by the port support portion is located between the first power storage module and the third power storage module, and
the port support portion is provided such that displacement in the first direction is suppressed by the first bracket and the second bracket.

15. The power storage device according to claim 14, wherein
the cross member includes (i) a portion located opposite to the first cooler in the first direction of the second power storage module, (ii) a portion protruding toward the port support portion between the second power storage module and the fourth power storage module, and (iii) a portion located opposite to the second cooler in the first direction of the fourth power storage module.

16. A power storage device comprising:
a first power storage module and a second power storage module arranged in a first direction; and
a first cooler located between the first power storage module and the second power storage module, wherein
each of the first power storage module and the second power storage module includes a second target component at only one end portion of two end portions in the first direction, and
each of the first power storage module and the second power storage module is disposed such that the end portion including the second target component faces the first cooler.

17. The power storage device according to claim 16, wherein
the second target component included in the first power storage module is a component that generates heat during charging or discharging of the first power storage module, and
the second target component included in the second power storage module is a component that generates heat during charging or discharging of the second power storage module.

18. The power storage device according to claim 1, further comprising:
a third power storage module and a fourth power storage module arranged in the first direction; and
a second cooler that cools the third power storage module and the fourth power storage module, wherein
at least a part of the second cooler is located between the third power storage module and the fourth power storage module in the first direction,
the first power storage module and the third power storage module are disposed to be arranged in a second direction orthogonal to the first direction,
the second power storage module and the fourth power storage module are disposed to be arranged in the second direction,
the first cooler includes a first cooling port through which refrigerant flows into the first cooler, and a second cooling port through which the refrigerant flows out from the first cooler,
the second cooler includes a third cooling port through which the refrigerant flows into the second cooler, and a fourth cooling port through which the refrigerant flows out from the second cooler,
the first cooling port and the second cooling port are disposed to be arranged in a third direction orthogonal to both the first direction and the second direction, and
the third cooling port and the fourth cooling port are disposed to be arranged in the third direction.

19. The power storage device according to claim 18, wherein
the first cooling port and the third cooling port are connected to a common first flow path, and
the second cooling port and the fourth cooling port are connected to a common second flow path.
